(19) United States
(12) Patent Application Publication
(10) Pub. No.: US 2008/0104575 A1
(43) Pub. Date: May 1, 2008

(54) AGENT FOR IMPLEMENTING AUTOMATED COMPATIBILITY TEST

(75) Inventors: Xun-Yi Fan, Nanjing (CN); Feng Li, Nanjing (CN)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/554,795

(22) Filed: Oct. 31, 2006

(51) Int. Cl. G06F 9/44

(52) U.S. Cl. 717/124

(57) ABSTRACT

A method (400) of testing a device (105). The method can include receiving from the device a test request identifying at least one test to be performed on the device. The test request can be received in accordance with a first communications protocol. The test request can be communicated to a test tool (130) in accordance with a second communications protocol. Further, a response to the test request can be received from the test tool. The response can be received in accordance with the second communications protocol. The response then can be communicated to the device in accordance with the first communications protocol.

### BACKGROUND OF THE INVENTION

1. Field of the Invention

The present invention generally relates to testing of software implementation on devices and, more particularly, to automated solutions for performing such testing.

2. Background of the Invention

As computing technology has advanced, hardware and software has become increasingly complex, thereby making the task of insuring compatibility among different hardware and software systems more difficult. In order to insure that systems on which Sun Microsystems Java software is installed are compatible with the software, Sun Microsystems has introduced a set of tools called the Java Compatibility Test Tools (Java CTT). These tools are designed to help a specification lead person create a Technology Compatibility Kit (TCK).

A TCK is a suite of tests, tools, and documentation that provide a standard way of testing an implementation for compliance with a Java technology specification. It is one of the three major deliverables, along with a specification and reference implementation, that the Java Community Process Program (JCP) requires for the final release of a Java technology. Each TCK is unique to its associated Java technology, although all TCKs typically include a plurality of TCK tests, a test harness, and documentation. The TCK tests are test cases used to test an implementation for compliance with a Java technology specification. The test harness is the set of applications and tools that manage the TCK tests, for example by automatically loading the tests, helping to configure a device's environment to run the tests, and reporting test results. The documentation is usually provided in the form of a user's guide and describes how to use the TCK.

Sun Microsystems also provides the Java Device Test Suite (JDTS). JDTS simplifies quality assurance testing for certain Java implementations by providing a set of comprehensive tests and a test manager. The tests can include functional tests, stress tests, performance tests, security tests, and the like. The test manager implements the tests to enable users of the suite to evaluate, validate, and verify the quality of implementations of the Connected Limited Device Configuration (CLDC) and the Mobile Information Device Profile (MIDP) on a particular device. Together, TCK and JDTS help device manufacturers and service providers ensure that each of their products and services properly implement Java resources.

The traditional method to run TCK/JDTS on mobile telephones and mobile radios under test is to communicate with the test harness over a cellular communications network and receive the tests wirelessly. This is because mobile telephones and radios typically are not configured to support packet-switch based data exchange and the TCP/IP protocol on their wired communications ports. In a manufacturing environment, large numbers of these devices need to be tested to insure quality. To do so using the cellular communications network can be very costly. Moreover, cellular communications networks do not cover all regions where TCK/JDTS compliance testing is to be performed. One potential arrangement is to modify code for the Java test harness to enable a wired connection to a device under test. In particular, among other things, the code can be modified to change the test harness' HTTP server to an HTTPSerial Server. Such code modifications are undesirable, however.

### SUMMARY OF THE INVENTION

The present invention relates to a method of testing a device. The method can include receiving from the device a test request identifying at least one test to be performed on the device. The test request can be received in accordance with a first communications protocol. The test request can be communicated to a test tool in accordance with a second communications protocol. Further, a response to the test request can be received from the test tool. The response can be received in accordance with the second communications protocol. The response then can be communicated to the device in accordance with the first communications protocol.

The method further can include parsing data including the test request from a first message formatted in accordance with the first protocol. The data including the test request can be encoded into a second message formatted in accordance with the second communications protocol. Data including the response can be parsed from a third message formatted in accordance with the second protocol. The data including the response can be encoded into a fourth message formatted in accordance with the first communications protocol.

Communicating the test request to the test tool can include communicating the test request to a test harness. Communicating the response to the device also can include communicating at least one test case to be loaded on the device. Further, a test result generated in response to the test case being loaded on the device can be received from the device. The test result can be received in accordance with the first communications protocol. The test result can be communicated to the test tool in accordance with the second communications protocol. Communicating the response to the device can include communicating test configuration information. Communicating the response to the device also can include communicating a test manager to manage testing on the device.

The present invention also relates to a test apparatus for use in testing a device. The apparatus can include a communications port and an agent instantiated on the test apparatus. Via the communications port the agent can receive from the device a test request identifying at least one test to be performed on the device. The test request can be received in accordance with a first communications protocol. The agent can communicate the test request to at least one test tool in accordance with a second communications protocol. The agent also can receive from the test tool a response to the test request, the response being received in accordance with the second communications protocol. Further, via the communications port, the agent can communicate the response to the device in accordance with the first communications protocol.

The agent can parse data comprising the test request from a first message formatted in accordance with the first protocol. Further, the agent can encode the data comprising the test request into a second message. The agent also can parse data comprising the response from a third message formatted in accordance with the second protocol. Data comprising the response can be encoded into a fourth message formatted in accordance with the first communications protocol. The agent can communicate the test request to a test harness. The agent also can communicate to the device at least one test case to be loaded on the device.

In one arrangement the agent can receive from the device a test result generated in response to the test case being loaded on the device, the test result being received in accordance with the first communications protocol. Further, the agent can communicate the test result to the test tool in accordance with the second communications protocol. The agent can communicate to the device test configuration information or a test manager to manage testing on the device.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a system that is useful for understanding the present invention;

FIG. 2 depicts another system that is useful for understanding the present invention;

FIG. 3 depicts a block diagram of a test apparatus that is useful for understanding the present invention; and

FIG. 4 is a flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to an agent which may establish a communication channel between a device under test (hereinafter “device”) and a server which provides one or more test suites, for example a Technology Compatibility Kit (TCK) and/or a Java Device Test Suite (JDTS). The device and server may communicate using different communication protocols. The agent can convert messages received from the device into a protocol with which the server communicates, and convert messages received from the server into a protocol with which the device communicates. For example, if the device communicates via a communications port, such as a universal serial bus (USB) port, and the server communicates via TCP/IP, the agent can convert messages between the USB communications protocol and TCP/IP. Accordingly, the test suites can be implemented over wired TCP/IP connections to test a device which does not natively support wired TCP/IP communications.

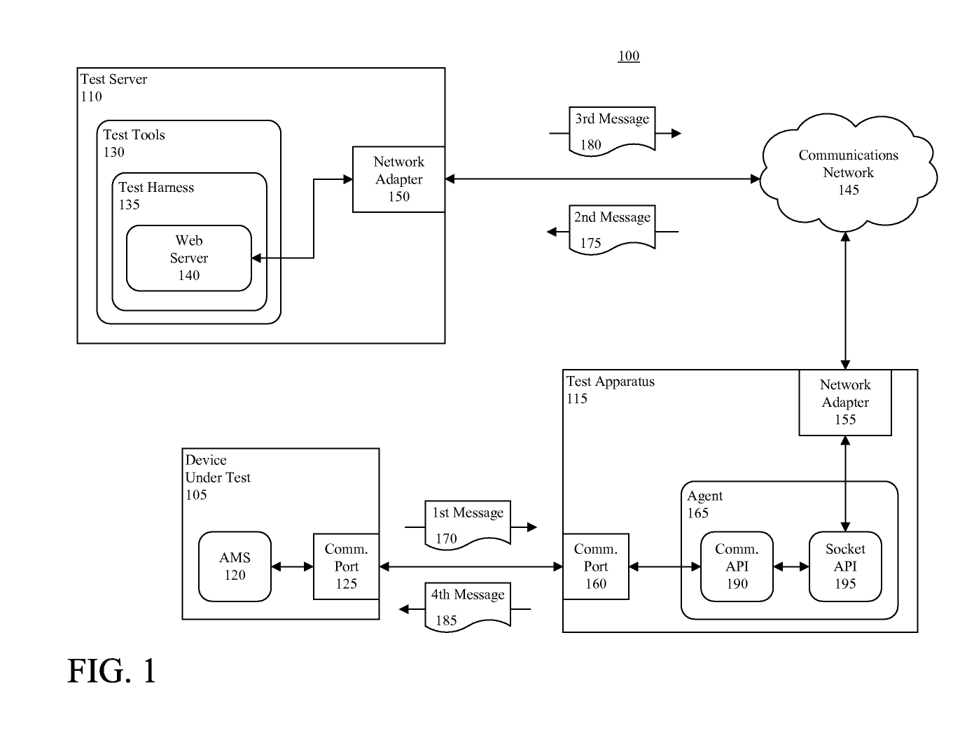

FIG. 1 depicts a system 100 that is useful for understanding the present invention. The system 100 can include a device 105 that is communicatively linked to a test server 110 via a test apparatus 115. The device 105 can include application management software (AMS) 120 that manages the downloading and lifecycle of applications that execute on the device 105. An example of the AMS 120 is a Java Application Manager, which manages MIDlets. As known to the skilled artisan, a MIDlet is a Java program for embedded devices that runs using the Java Platform, Micro Edition (Java ME) virtual machine. Still, other AMS can be used and the invention is not limited in this regard.

The device 105 also can include a communications port 125. The communications port 125 can be a universal serial bus (USB) port (e.g. a standard USB port, a mini USB port or a micro USB port), an IEEE-1394 port, a personal area network (PAN) adapter (e.g. Bluetooth or ZigBee adapter), or any other suitable communications port. The communications port 125 can include a suitable transceiver. For example, in an arrangement in which the communications port 125 comprises a USB port, the communications port 125 can include a USB transceiver. In an arrangement in which the communications port 125 comprises an IEEE-1394 port, the communications port 125 can include an IEEE-1394 transceiver. In an arrangement in which the communications port 125 comprises a PAN adapter, the communications port 125 can include a PAN transceiver.

The device 105 also can include a processor, a transceiver, a data store, and/or any other suitable device components. In one arrangement, the device 105 can be a mobile station, such as a mobile telephone, a mobile radio, a personal digital assistant, or the like, which communicates via CDMA. Nonetheless, the invention is not limited in this regard and the device 105 can be any other apparatus which may be communicatively linked to the test server 110 via the test apparatus 115 to undergo testing.

The test server 110 can include a suite of test tools 130. Examples of such a suite include, but are not limited to, a Technology Compatibility Kit (TCK) and a Java Device Test Suite (JDTS). Nonetheless, other test suites can be used and the invention is not limited to these examples. In one arrangement, the suite of test tools 130 can include a test harness 135, for example a Java test harness. A test harness is a set of tools included in the suite of test tools 130 that manage the tests performed by the suite of test tools 130. For example, the test harness can automatically load the tests, help to configure the environment to run the tests on the device 105, and report test results. The test reports can be stored on the test server 110, communicated to a compliance verification authority, or processed in any other suitable manner.

The suite of test tools 130 also can include a web server 140. The web server 140 can receive requests communicated to the test server 110 via a communications network 145, for instance via the Internet, the World Wide Web, a wide area network (WAN), a local area network (LAN), or any other suitable communications network. For example, the web server 140 can receive HTTP messages requesting resources provided by the suite of test tools 130, and respond with HTTP messages comprising requested resources, for instance test cases to be loaded onto the device 105 for testing purposes, test configuration data and/or a test manager to manage testing of the device 105. A network adapter 150 can be provided to communicatively link the test server 110 to the communications network 145. The network adapter 150 can communicate via TCP/IP or any other protocol suitable for communicating via the communications network 145.

The test apparatus 115 also can include a network adapter 155 that communicatively links the test apparatus 115 to the test server 110 via the communications network 145. The network adapter 155 also can communicate via TCP/IP or any other suitable protocol. The test apparatus 115 also can include a communications port 160. The communications port 160 can be a USB port, an IEEE-1394 port, a PAN adapter, or any other suitable communications port. The communications port 160 can include a suitable transceiver. For example, the communications port 160 can comprise a USB transceiver, an IEEE-1394 transceiver and/or a PAN transceiver.

The test apparatus 115 also can include an agent 165 that implements protocol conversion. The agent 165 can receive from the device 105 a request for test resources provided the suite of test tools 130, for instance resources hardware and software components of the device 105. Such resources can include a Java ME virtual machine instantiated on the device 105 and applications executed by the Java ME virtual machine. The agent 165 can receive from the device 105, via the communications port 160, a first message 170 that comprises the test request. The first message 170 can be formatted and communicated in accordance with a first protocol, for example the HTTPSerial protocol.

The agent 165 then can convert the test request from the first protocol to a second protocol, for instance a socket based TCP/IP protocol, and communicate the test request to the test tools' web server 140. In particular, the test request can be communicated to the web server 140. The agent 165 can parse data comprising the test request from the first message 170 and encode the data in a second message 175 formatted in accordance with the second protocol. The second message 175 can be communicated to the test tools 130 via the network adapter 155 and the communications network 145.

The agent 165 also can receive a response to the test request from the test tools' web server 140. The response can be, for example, a TCK and/or JDTS test response generated by the tools 130. The test response can be contained in one or more messages, for instance a third message 180 formatted and communicated in accordance with the second protocol. The third message 180 can be received via the communications network 145 and the network adapter 155.

The agent 165 then can convert the test response from the second protocol to the first protocol, and communicate the protocol converted response to the device 105. For example, the agent 165 can parse data comprising the test response from the third message 180 and encode the data in a fourth message 185 formatted in accordance with the first protocol. The Agent then can communicate the fourth message 185 to the device 105 via the communications port 160.

Further, the agent 165 can receive additional information from the device 105, for instance test data or test results, convert such information from the first protocol to the second protocol, and communicate the information to the test server 110. For example, the agent 165 can parse the information from one or more messages formatted in accordance with the first protocol and encode the information in one or more messages formatted in accordance with the second protocol and communicate such messages to the test tools' web server 140. The test tools 130 can process such information and, if appropriate, reply with further responses, for example a response comprising a compliance certificate. Again, such responses also can be communicated to the agent 165 for protocol conversion prior to being communicated to the device 105.

Notably, even if the device 105 is not configured to communicate via the communications network 145 (e.g. not configured to communicate using TCP/IP over a wired connection), the test apparatus 115 can relay information between the device 105 and the test server 110 without distorting the information. In an arrangement in which the device 105 is a mobile station, rather than receiving TCK and JDTS tests via a cellular communications network, the device 105 can receive such tests from the test apparatus 115, which itself can receive the tests over an inexpensive wired communication link, such as a conventional wired Internet connection.

Further, as known to those skilled in the art, a wired Internet connection can provide much greater bandwidth than an over-the-air Internet connection using a cellular communications network. Moreover, the wired Internet connection may be available in regions which still do not have adequate access to a cellular communications network. Further, testing can be performed on the device 105 without requiring modifications to the test environment or modifications to test suite program code. For instance, the TCK and JDTS suites can be implemented without modifying their respective code.

The agent 165 can comprise software instantiated on the test apparatus 115. For example, the agent 165 can include a communications port application program interface (API) 190 and a socket API 195. The communications port API 190 can receive the first message 170 from the communications port 160 and parse the content of the first message 170. The communications port API 190 can pass such content to the socket API 195. The socket API 195 then can encode the content into the second message 175 and communicate the second message 175 to the network adapter 155 for communication to the test tools 130 on the test server 110. Similarly, the socket API 195 can receive the third message 180 and parse the content of the third message 180. The socket API 195 can pass such content to the communications port API 190. The communications port API then can encode the content into the fourth message 185 and communicate the fourth message 185 to the communications port 160 for communication to the device 105.

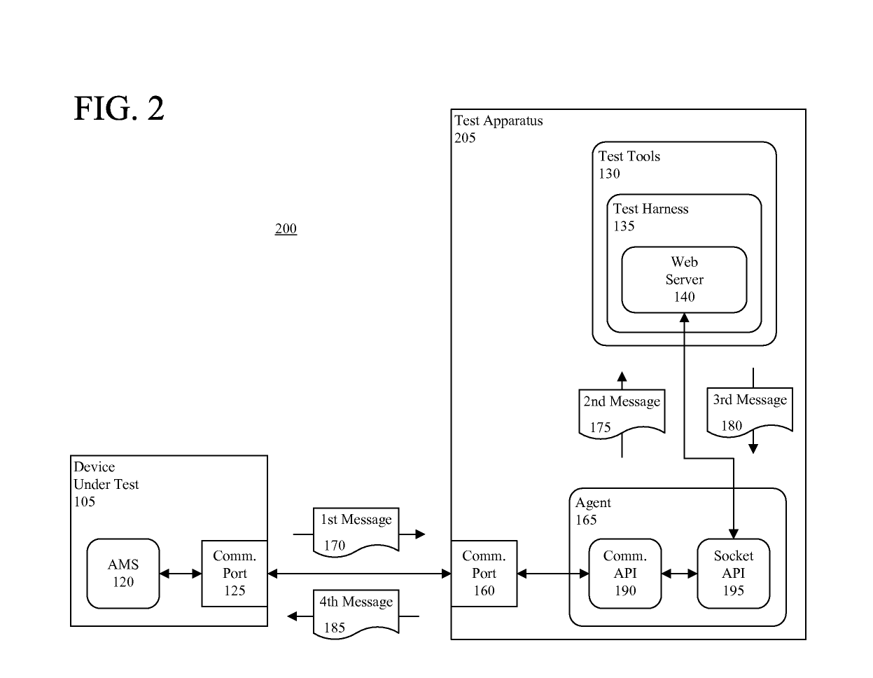

FIG. 2 depicts another system 200 that is useful for understanding the present invention. In the system 200, the test server need not be provided. Instead, the test apparatus 205 can include the suite of test tools 130, test harness 135, web server 140, communications port 160 and agent 165. Even though the web server 140 may be configured to function in a network environment, the agent 165 and web server 140 can communicate using a suitable communications protocol that need not be communicated over a network. For instance, both the web server 140 and agent 165 can be configured to communicate via network communications protocol, for example the HTTP protocol.

As previously described, the agent 165 can receive a test request from the device 105 via the communications port 160, convert the test request to the second protocol, and communicate the protocol converted request to the web server 140. Similarly, the agent 165 can receive the test response from the web server 140 in accordance with the second protocol, convert the test response to the first protocol, and communicate the protocol converted test response to the device 105 via the communications port 160. The agent 165 can implement such communications using the messages 170-185 previously described.

Because the web server 140 and agent 165 are contained in the same test apparatus 205, the network adapters may not be required. Further, there is no need to communicate the messages 175-180 over a communications network, thereby reducing cost of operation and eliminating network related latency, which improves system performance.

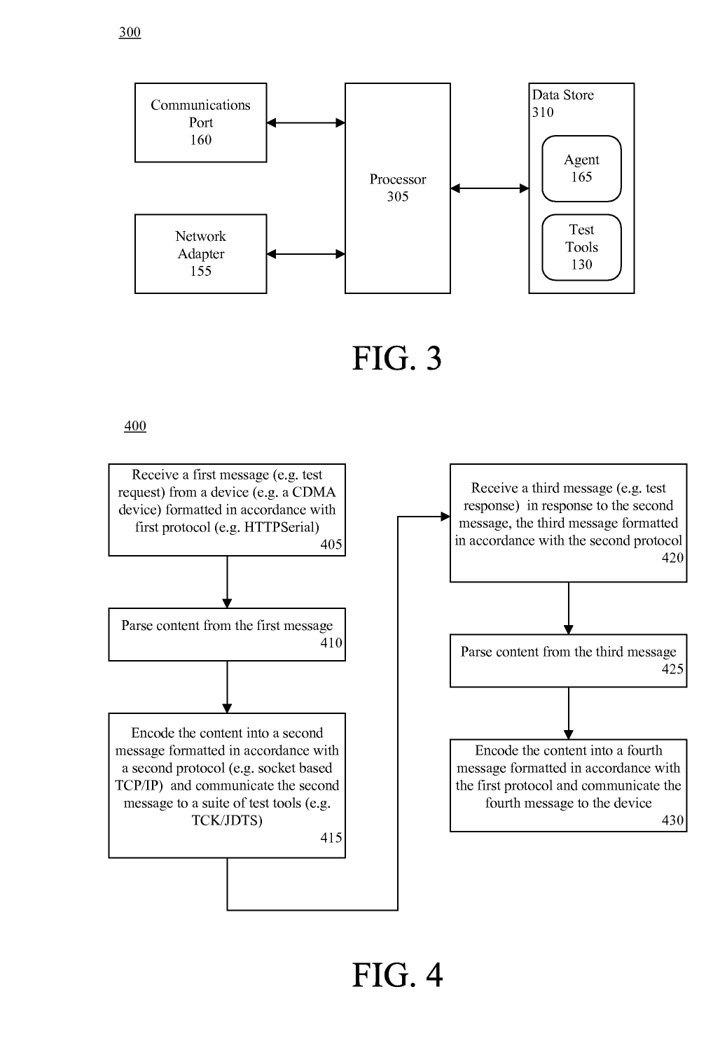

FIG. 3 depicts a block diagram of a test apparatus 300 that is useful for understanding the present invention. The test apparatus 300 can include a processor 305. The processor 305 can comprise, for example, a central processing unit (CPU), a digital signal processor (DSP), an application specific integrated circuit (ASIC), a programmable logic device (PLD), a plurality of discrete components that cooperate to process data, and/or any other suitable processing device.

The test apparatus 300 can include the communications port 160. As noted, the communications port 160 can be a USB port, an IEEE-1394 port, a PAN adapter or any other suitable communications port, and can include a suitable transceiver. The test apparatus 300 optionally can include a network adapter 155. As noted, the network adapter 155 also can communicate via TCP/IP or any other suitable protocol.

The test apparatus 300 also can include a data store 310. The data store 310 can include one or more storage devices, each of which can include a magnetic storage medium, an electronic storage medium, an optical storage medium, a magneto-optical storage medium, and/or any other storage medium suitable for storing digital information. The agent 165 can be contained on the data store 310. At runtime, the agent 165 can be executed by the processor 305 to implement the protocol conversion methods and processes described herein. In an arrangement in which the test apparatus includes the suite of test tools 130, the suite of test tools 130 also can be contained on the data store 310, and portions of the suite (e.g. the web server and test harness) can be executed by the processor 305 at runtime.

FIG. 4 is a flowchart that presents a method 400 that is useful for understanding the present invention. The process can begin in a state in which the agent is waiting for data via a communications port, for instance via a serial port such as a USB port. At step 405, the agent can receive a first message from a device. The first message can comprise, for example, a request to receive testing information in accordance with TCK and/or JDTS. The requested testing information can include test configuration data, a test manager and/or test cases. The first message can be formatted and communicated in accordance with a first protocol, for instance the HTTPSerial protocol.

Proceeding to step 410, the content (e.g. request) of the first message can be parsed from the message. At step 415, the content can be encoded into a second message formatted in accordance with a second protocol. In one arrangement, the second message can be formatted in accordance with a socket based TCP/IP protocol. The second message then can be communicated in accordance with the second protocol to a suite of test tools. The suite of test tools can comprise, for instance, TCK and/or JDTS.

Continuing to step 420, a third message can be received from the suite of test tools. The third message can include a response fulfilling the test request with test configuration data, a test manager and/or test cases. The third message can be formatted and communicated in accordance with the second protocol. At step 425, the content can be parsed from the third message. At step 430, the content can be encoded into a fourth message formatted in accordance with the first protocol and the fourth message can be communicated to the device in accordance with the first protocol.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method of testing a device, comprising:
receiving from the device a test request identifying at least one test to be performed on the device, the test request being received in accordance with a first communications protocol;
communicating the test request to at least one test tool in accordance with a second communications protocol;
receiving from the test tool a response to the test request, the response being received in accordance with the second communications protocol; and
communicating the response to the device in accordance with the first communications protocol.

2. The method of claim 1, further comprising parsing data comprising the test request from a first message formatted in accordance with the first protocol.

3. The method of claim 2, further comprising encoding the data comprising the test request into a second message formatted in accordance with the second communications protocol.

4. The method of claim 1, further comprising parsing data comprising the response from a third message formatted in accordance with the second protocol.

5. The method of claim 4, further comprising encoding the data comprising the response into a fourth message formatted in accordance with the first communications protocol.

6. The method of claim 1, wherein communicating the test request to the test tool comprises communicating the test request to a test harness.

7. The method of claim 1, wherein communicating the response to the device comprises communicating at least one test case to be loaded on the device.

8. The method of claim 7, further comprising:
receiving from the device a test result generated in response to the test case being loaded on the device, the test result being received in accordance with the first communications protocol; and
communicating the test result to the test tool in accordance with the second communications protocol.

9. The method of claim 1, wherein communicating the response to the device comprises communicating test configuration information.

10. The method of claim 8, wherein communicating the response to the device comprises communicating a test manager to manage testing on the device.

11. A test apparatus for use in testing a device, comprising:
a communications port; and
an agent instantiated on the test apparatus;
wherein:
via the communications port the agent receives from the device a test request identifying at least one test to be performed on the device, the test request being received in accordance with a first communications protocol;
the agent communicates the test request to at least one test tool in accordance with a second communications protocol;
the agent receives from the test tool a response to the test request, the response being received in accordance with the second communications protocol; and
via the communications port the agent communicates the response to the device in accordance with the first communications protocol.

12. The test apparatus of claim 11, wherein the agent parses data comprising the test request from a first message formatted in accordance with the first protocol.

13. The test apparatus of claim 12, wherein the agent encodes the data comprising the test request into a second message formatted in accordance with the second communications protocol.

14. The test apparatus of claim 10, wherein the agent parses data comprising the response from a third message formatted in accordance with the second protocol.

15. The test apparatus of claim 14, wherein the agent encodes the data comprising the response into a fourth message formatted in accordance with the first communications protocol.

16. The test apparatus of claim 11, wherein the agent communicates the test request to a test harness.

17. The test apparatus of claim 11, wherein the agent communicates to the device at least one test case to be loaded on the device.

18. The test apparatus of claim 17, wherein:
the agent receives from the device a test result generated in response to the test case being loaded on the device, the test result being received in accordance with the first communications protocol; and
the agent communicates the test result to the test tool in accordance with the second communications protocol.

19. The test apparatus of claim 11, wherein the agent communicates to the device a test manager to manage testing on the device or test configuration information.

20. A machine readable storage, having stored thereon a computer program having a plurality of code sections comprising:
code that receives from the device a test request identifying at least one test to be performed on the device, the test request being received in accordance with a first communications protocol;
code that communicates the test request to at least one test tool in accordance with a second communications protocol;
code that receives from the test tool a response to the test request, the response being received in accordance with the second communications protocol; and
code that communicates the response to the device in accordance with the first communications protocol.
